(19) United States
(12) Patent Application Publication
(10) Pub. No.: US 2026/0057508 A1
(43) Pub. Date: Feb. 26, 2026

(54) IMAGE INSPECTION APPARATUS, IMAGE INSPECTION METHOD, AND A NON-TRANSITORY COMPUTER-READABLE STORAGE MEDIUM STORING IMAGE INSPECTION PROGRAM

(71) Applicant: Keyence Corporation, Osaka (JP)

(72) Inventors: Manabu KIDO, Osaka (JP); Tsubasa TERASHIGE, Osaka (JP)

(73) Assignee: Keyence Corporation, Osaka (JP)

(21) Appl. No.: 19/266,235

(22) Filed: Jul. 11, 2025

(30) Foreign Application Priority Data
Aug. 20, 2024 (JP) 2024-138396
Jan. 24, 2025 (JP) 2025-010236

(51) Int. Cl. G06T 7/00; G06V 10/74; G06V 10/82; G06V 10/98; G06V 30/12; G06V 30/19; G06V 30/242

(52) U.S. Cl. CPC G06T 7/001; G06V 10/761; G06V 10/82; G06V 10/993; G06V 30/133; G06V 30/19093; G06V 30/242; G06T 2207/20084; G06T 2207/30164; G06V 2201/06

(57) ABSTRACT

A control unit of an image inspection apparatus executes the OCR tool as the inspection tool. When the OCR tool is executed, the control unit inputs a workpiece image including a character image region to the neural network, and acquires a character type recognition result indicating a character type of a unit character image region and a position of the unit character image region based on information related to a character type recognizable by the OCR tool. Further, the control unit calculates a quality score indicating a degree of similarity between a master image corresponding to a character type indicated in the character type recognition result and an image of the unit character image region based on the position of the unit character image region, and outputs the quality score in association with the character type indicated in the character type recognition result.

### CROSS-REFERENCE TO RELATED APPLICATIONS

The present application claims foreign priority based on Japanese Patent Application No. 2024-138396, filed Aug. 20, 2024 and No. 2025-010236, filed Jan. 24, 2025, the contents of which are incorporated herein by references.

### BACKGROUND OF THE INVENTION

### 1. Technical Field

The invention relates to an image inspection apparatus, an image inspection method, and an image inspection program that execute an OCR tool as an inspection tool.

### 2. Description of the Related Art

JP4909216B discloses an image processing system that captures an image of a character printed on a medium and analyzes the image in an image processing apparatus. The medium may be, for example, a medium attached to a product or a packaging of a merchandise product itself.

### SUMMARY OF THE INVENTION

The image processing apparatus recognizes the character printed on the product or the merchandise to perform a confirmation work such as a manufacturing process and a conveyance process of the product or the merchandise.

It is conceivable to perform character recognition processing described in JP4909216B using a neural network. In a case where the character recognition processing is performed by using the neural network, while there is an advantage that a character type related to an image can be recognized from images of various forms, there may be a problem that a character type of a character image to be determined to be abnormal by visual inspection by a person is normally recognized and an appropriate inspection result cannot be obtained.

An object of the invention is to provide an image inspection apparatus, an image inspection method, and an image inspection program capable of obtaining an appropriate inspection result in a case where an OCR tool as an inspection tool is executed by using a neural network.

An image inspection apparatus according to the invention includes an image acquisition unit that acquires a workpiece image on which a workpiece appears, an inspection execution unit that executes an inspection tool and outputs an inspection result for the workpiece image, and an inspection setting unit that accepts setting for the inspection tool. The inspection setting unit accepts, as setting related to an OCR tool as the inspection tool, registration of a master image in association with a character type recognizable by the OCR tool, the inspection execution unit executes the OCR tool as the inspection tool and then, inputs one of the workpiece image including a character image region and an image of a unit character image region of the workpiece image, to a neural network to acquire a character type recognition result as the inspection result indicating a character type of the unit character image region and a position of the unit character image region based on information related to the recognizable character type, calculates a quality score indicating a degree of similarity between the master image corresponding to the character type indicated in the character type recognition result and the image of the unit character image region, based on the position of the unit character image region, and outputs the quality score in association with the character type indicated in the character type recognition result.

According to the image inspection apparatus of the invention, not only the character type indicated in the character type recognition result but also the quality score is output in association with the character type. The quality score is used, and thus, an appropriate inspection result can be obtained in a case where the OCR tool as the inspection tool is executed by using the neural network.

An image inspection method according to the invention includes an image acquisition step of acquiring a workpiece image on which a workpiece appears, an inspection execution step of executing an inspection tool and outputting an inspection result for the workpiece image, and an inspection setting step of accepting setting for the inspection tool. In the inspection setting step, registration of a master image is accepted, as setting related to an OCR tool, in association with a character type recognizable by the OCR tool as the inspection tool, in the inspection execution step, the OCR tool as the inspection tool is executed, one of the workpiece image including a character image region and an image of a unit character image region of the workpiece image is input to a neural network to acquire a character type recognition result as the inspection result indicating a character type of the unit character image region and a position of the unit character image region based on information related to the recognizable character type, a quality score indicating a degree of similarity between the master image corresponding to the character type indicated in the character type recognition result and the image of the unit character image region is calculated based on the position of the unit character image region, and the quality score is output in association with the character type indicated in the character type recognition result.

According to the image inspection method of the invention, not only the character type indicated in the character type recognition result but also the quality score is output in association with the character type. The quality score is used, and thus, an appropriate inspection result can be obtained when the OCR tool as the inspection tool is executed by using the neural network.

An image inspection program according to the invention causes an image inspection apparatus to function as an image acquisition section that acquires a workpiece image on which a workpiece appears, an inspection execution section that executes an inspection tool and outputs an inspection result for the workpiece image, and an inspection setting section that accepts setting for the inspection tool. The inspection setting section accepts, as setting related to an OCR tool as the inspection tool, registration of a master image in association with a character type recognizable by the OCR tool, the inspection execution section executes the OCR tool as the inspection tool and then, inputs one of the workpiece image including a character image region and an image of a unit character image region of the workpiece image, to a neural network to acquire a character type recognition result as the inspection result indicating a character type of the unit character image region and a position of the unit character image region based on information related to the recognizable character type, calculates a quality score indicating a degree of similarity between the master image corresponding to the character type indicated in the character type recognition result and an image of the unit character image region, based on the position of the unit character image region, and outputs the quality score in association with the character type indicated in the character type recognition result.

According to the image inspection program of the invention, not only the character type indicated in the character type recognition result but also the quality score is output in association with the character type. The quality score is used, and thus, an appropriate inspection result can be obtained when the OCR tool as the inspection tool is executed by using the neural network.

### BRIEF DESCRIPTION OF THE DRAWINGS

FIG. 1 is a schematic diagram of an image inspection apparatus according to a first embodiment of the invention;

FIG. 2 is a block diagram showing an electrical configuration of the image inspection apparatus of FIG. 1;

FIG. 3 is a flowchart illustrating a setting flow for an OCR tool executed by a control unit in FIG. 1;

FIG. 4 is a schematic diagram illustrating an example of a screen to be displayed on a display when the control unit accepts an addition instruction in step S4 of FIG. 3;

FIG. 5 is a schematic diagram illustrating an example of the screen to be displayed on the display subsequently to the screen of FIG. 4 when the control unit accepts the addition instruction in step S4 of FIG. 3;

FIG. 6 is a schematic diagram illustrating an example of a screen to be displayed on the display subsequently to the screen of FIG. 5 when the control unit accepts the addition instruction in step S4 of FIG. 3;

FIG. 7 is a schematic diagram illustrating an example of a screen to be displayed on the display when the control unit accepts registration of a master image in step S7 of FIG. 3 and a state in which a user is selecting one of a plurality of candidates for the master image;

FIG. 8 is a schematic diagram illustrating an example of a screen to be displayed on the display subsequently to the screen of FIG. 7 when the control unit accepts the registration of the master image in step S7 of FIG. 3 and a state in which the user selects, as the master image, one of the plurality of candidates for the master image;

FIG. 9 is a flowchart illustrating an OCR tool execution flow executed by the control unit in FIG. 1;

FIG. 10 is a schematic diagram illustrating an example of a screen to be displayed on the display by the control unit in step S24 of FIG. 9;

FIG. 11 is a schematic diagram illustrating a modification of a screen to be displayed on the display by the control unit in step S24 of FIG. 9; and

FIG. 12 is a functional block diagram illustrating functions of the control unit in FIG. 1.

### DETAILED DESCRIPTION

### First Embodiment

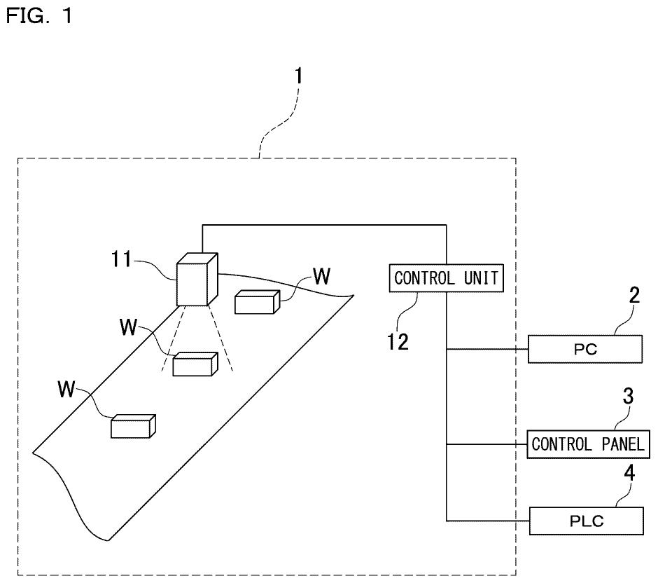

First, an overall configuration of an image inspection apparatus 1 according to a first embodiment of the invention will be described with reference to FIG. 1. The image inspection apparatus 1 is used, for example, in a product manufacturing line.

The image inspection apparatus 1 includes an imaging unit 11 that captures an image of a workpiece W, which is a product conveyed by a conveyance unit, and a control unit 12. The imaging unit 11 and the control unit 12 are electrically connected.

The imaging unit 11 includes a lens, a camera module including an imaging element, an illumination module for illuminating the workpiece W, and a control board for controlling each module. The imaging unit 11 generates data of a workpiece image on which the workpiece W appears, and transmits the data to the control unit 12. The imaging unit 11 according to the present embodiment has a configuration in which the lens and the illumination module are integrated, but may have a configuration in which the lens can be replaced or a configuration in which the illumination module can be externally expanded in accordance with a type of the workpiece W and an imaging environment.

The control unit 12 acquires the workpiece image by receiving the data from the imaging unit 11. That is, the control unit 12 corresponds to an “image acquisition unit” and an “image acquisition section”according to the invention.

The control unit 12 further executes an inspection tool to be described later as an image inspection on the acquired workpiece image, and outputs an inspection result for the workpiece image. That is, the control unit 12 corresponds to an “inspection execution unit” and an “inspection execution section”according to the invention.

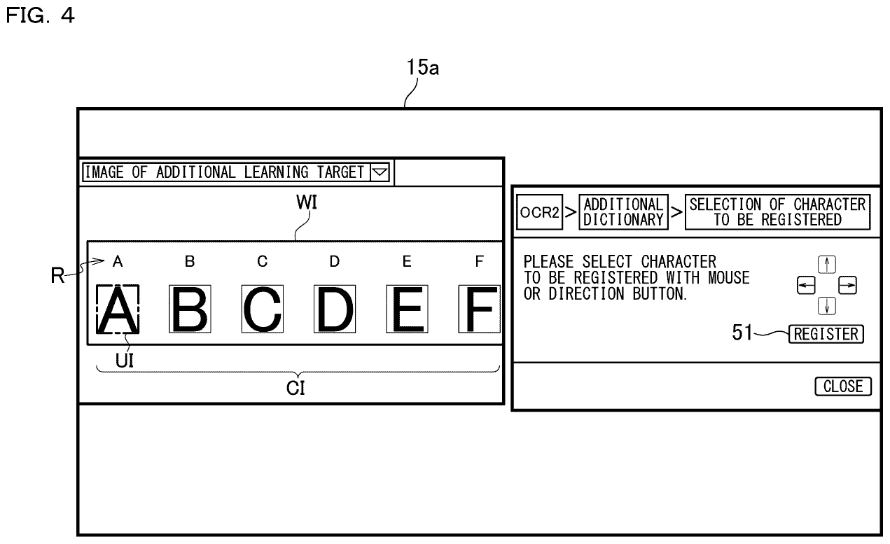

The image inspection apparatus 1 is used in a state in which an input and output unit that is an external device is electrically connected to the control unit 12. In the present embodiment, a PC 2, a control panel 3, and a PLC 4 correspond to an input and output unit which is an external device. The external device is a device outside the image inspection apparatus 1 and is not included in the image inspection apparatus 1. The input and output unit performs at least one of generation of an input to the control unit 12 and reception of an output from the control unit 12. The PC 2 includes a display 15a (see FIGS. 4 to 8), and a mouse and a keyboard. A user of the image inspection apparatus 1 can input desired setting information to the control unit 12 via the PC 2 by operating a mouse or a keyboard. The PC 2 can accept an output from the control unit 12, and displays the workpiece image acquired by the control unit 12 from the imaging unit 11 and an inspection result for the workpiece image on the display 15a. The control panel 3 includes a touch panel type display. The control panel 3 can display the workpiece image output from the control unit 12 and the inspection result for the workpiece image, and can input information based on an operation for the display to the control unit 12. The PLC 4 is electrically connected to the conveyance unit that conveys the workpiece W, and controls conveyance by the conveyance unit. The PLC 4 can transmit a trigger input for controlling a timing of capturing the image of the workpiece W to the control unit 12 based on the control of conveyance by the conveyance unit. The control unit 12 transmits an ON or OFF output based on the inspection result for the workpiece image to the PLC 4. The PLC 4 performs predetermined control based on the ON or OFF output acquired from the control unit 12. For example, in a case where the conveyance unit has a sorter that sorts products, the PLC 4 controls the sorter such that the products are sorted based on the ON or OFF output acquired from the control unit 12.

The control unit 12 accepts setting for the inspection tool based on a signal received from the input and output unit. That is, the control unit 12 corresponds to an “inspection setting unit”and an “inspection setting section”according to the invention.

In the present embodiment, the imaging unit 11 captures the image of the workpiece W conveyed by the conveyance unit, but may be configured to capture the image of the workpiece W being conveyed or may be configured to capture the image of the workpiece W in a stationary state. In addition, in the present embodiment, a timing of capturing an image by the imaging unit 11 is controlled by the PLC 4 that controls both the control unit 12 and the conveyance unit, but the invention is not limited thereto. For example, the PLC 4 or the control unit 12 may accept a sensor output for detecting that the workpiece W is positioned within an imaging field of view of the imaging unit 11, and the timing of capturing the image by the imaging unit 11 may be controlled based on the sensor output. Alternatively, the imaging unit 11 may be configured to acquire frame images (images of frames constituting a moving image) at all times, and the imaging unit 11 may be configured to generate data of the workpiece image as an inspection target in a case where the frame images satisfy a predetermined condition.

In addition, the image inspection apparatus 1 of the present embodiment includes the imaging unit 11, but may not include the imaging unit 11. For example, the control unit 12 may be connected to an imaging device as an external device to acquire the workpiece image from the imaging device.

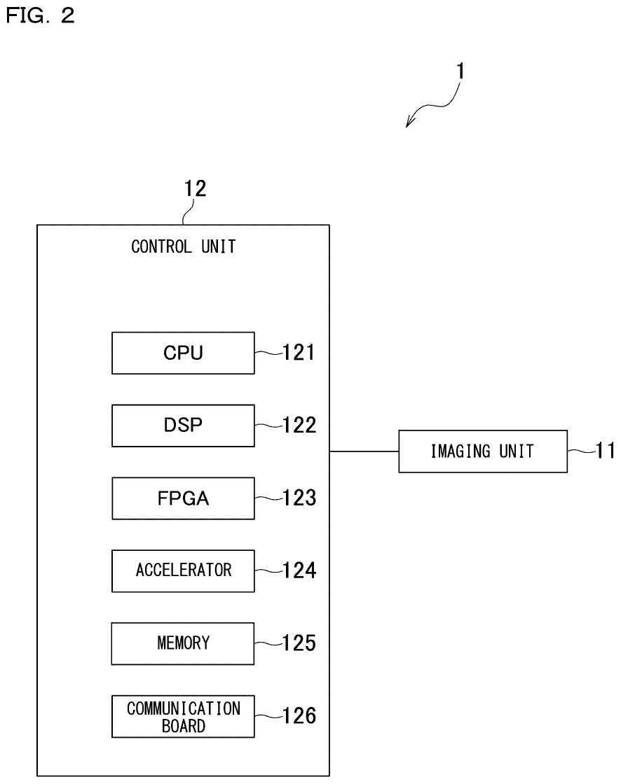

Next, an electrical configuration of the image inspection apparatus 1 will be described with reference to FIG. 2.

The control unit 12 includes a CPU 121, a DSP 122, an FPGA 123, an accelerator 124, a memory 125 including a RAM and a ROM, and a communication board 126.

The CPU 121 controls the entire image inspection apparatus 1. The DSP 122 and the FPGA 123 execute various types of signal processing. The accelerator 124 accelerates signal processing by the DSP 122 and the FPGA 123.

The memory 125 stores the workpiece image acquired from the imaging unit 11, information input from the input and output unit connected to the control unit 12, and the like.

The memory 125 further stores an image inspection program according to the invention. More specifically, the memory 125 stores a program in which a function of the inspection tool is described, data used in each program, and the like.

The communication board 126 is electrically connected to each of the PC 2, the control panel 3, and the PLC 4 which are external devices connected to the control unit 12. The control unit 12 transmits and receives signals to and from an external device via the communication board 126.

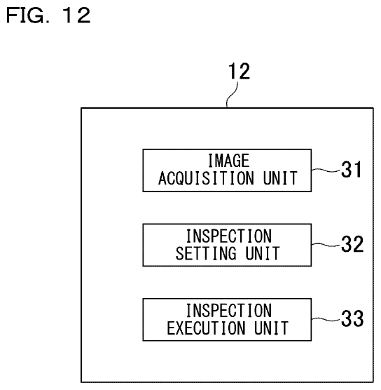

Next, a functional configuration of the control unit 12 will be described with reference to FIG. 12. The control unit 12 includes an image acquisition unit 31, an inspection setting unit 32, and an inspection execution unit 33.

The image acquisition unit 31 acquires the workpiece image generated by the imaging unit 11. The image acquisition unit 31 sends the workpiece image to the inspection execution unit 33. The workpiece image acquired from the imaging unit 11 by the image acquisition unit 31 is also stored in the memory 125.

The inspection setting unit 32 accepts setting information from the external device connected to the control unit 12. The inspection setting unit 32 acquires the workpiece image from the memory 125, generates GUI information for accepting the setting information by using the workpiece image, and outputs the GUI information to the external device. The setting information accepted by the inspection setting unit 32 includes an execution order of the inspection tool and reference information of the inspection tool. The inspection setting unit 32 stores the accepted setting information in the memory 125.

The inspection tool in the image inspection apparatus 1 is a program that defines image processing to be executed by the image inspection apparatus 1 for image inspection, and performs a constant output for an input image. The user of the image inspection apparatus 1 causes the image inspection apparatus 1 to execute a desired image inspection by combining inspection tools. Thus, the user operates the external device to input, as the setting information, the execution order of the inspection tool used for the image inspection and the reference information to be referred to when the inspection tool is executed to the control unit 12.

The image inspection apparatus 1 according to the present embodiment includes, as the inspection tools, an OCR tool, an area measurement tool, and a counting tool. The OCR tool is a tool that optically recognizes characters in an inspection region of the workpiece image. The user sets, as the reference information, information indicating the inspection region in the workpiece image, a dictionary to be described later, and information related to a quality score. The area measurement tool is a tool that discriminates an area of a portion having a predetermined color and brightness in the inspection region. The user sets, as the reference information, information indicating the inspection region in the workpiece image and color and brightness information. The counting tool is a tool that counts an object having a predetermined shape in the inspection region of the workpiece image. The user sets, as the reference information, information indicating the inspection region, a shape of a counting target object, and a threshold to be compared with a count number.

The inspection execution unit 33 executes the inspection tool on the workpiece image acquired from the imaging unit 11 by the image acquisition unit 31. At this time, the inspection execution unit 33 reads the setting information stored in the memory 125 by the inspection setting unit 32, and executes the inspection tool according to the setting information. The inspection execution unit 33 outputs an inspection result obtained as a result of executing the inspection tool to the external device connected to the control unit 12. The inspection result output to the external device varies depending on an output destination of the inspection result. The inspection result output to the PC 2 or the control panel 3 includes display information for displaying the workpiece image and an execution result of the inspection tool for the workpiece image. The display information may include information for displaying the inspection region of the inspection tool and the inspection result to be superimposed on the workpiece image. The inspection result output to the PLC 4 includes information in a form that can be processed by a control program executed by the PLC 4. The inspection result output to the PLC 4 may include display information similar to the inspection result output to the PC 2 or the control panel 3.

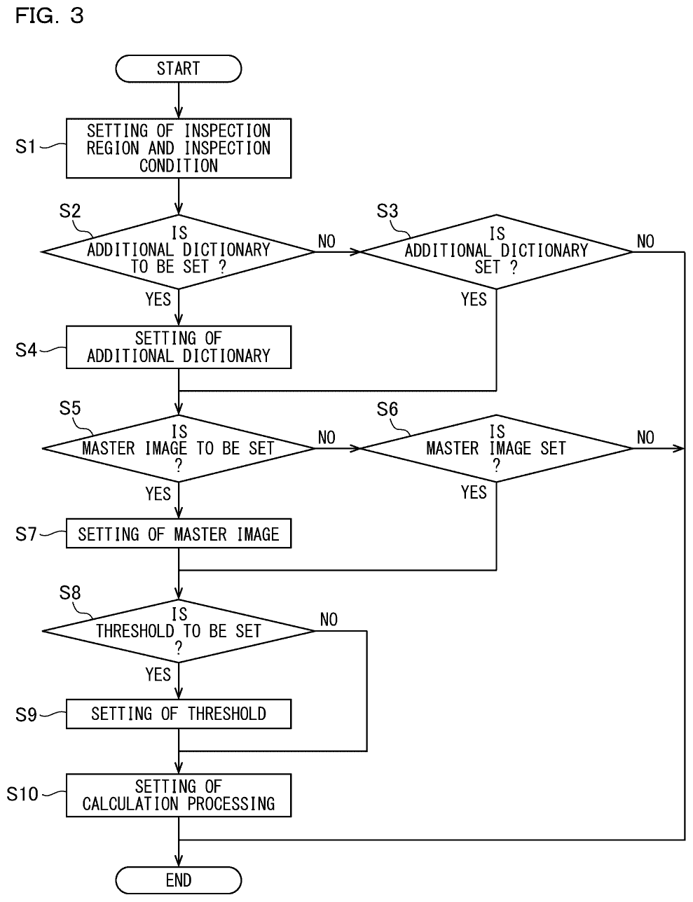

Next, a setting flow for the OCR tool executed by the control unit 12 will be described with reference to FIG. 3. Each kind of processing of the setting flow corresponds to an “inspection setting step” according to the invention. The following kinds of processing are executed by the CPU 121 of the control unit 12 as the inspection setting unit.

First, the control unit 12 accepts information indicating an inspection region in the workpiece image and an inspection condition for determining an output as the OCR tool based on a character recognition result (step S1). In step S1, the control unit 12 displays the workpiece image on the display 15a of the PC 2, and accepts information indicating the inspection region by a user operation on the displayed workpiece image. The control unit 12 stores the information indicating the inspection region in the memory 125 in association with the inspection tool to be set. In addition, the control unit 12 accepts the inspection condition via the PC 2. The inspection condition is, for example, a character string. In a case where the recognized character matches the character string, the execution result of the OCR tool is output as “non-defective”.

After step S1, the control unit 12 determines whether or not a signal indicating an addition instruction for updating a character type recognizable by the OCR tool is received from the PC 2 (step S2). For example, the signal is transmitted from the PC 2 to the control unit 12 in response to the user selecting a GUI element displayed on the display 15a of the PC 2.

The image inspection apparatus 1 is shipped in a state in which the OCR tool can recognize certain characters. That is, at the time of shipment of the image inspection apparatus 1, the memory 125 stores a built-in dictionary. The memory 125 stores, as the built-in dictionary, a character type and data for recognizing a character image as a predetermined character type in association with each other. When the inspection execution unit 34 executes the OCR tool as the inspection tool, the inspection execution unit 34 recognizes characters of the workpiece image while referring to the built-in dictionary stored in the memory 125.

The addition instruction accepted by the control unit 12 means that the additional dictionary to be referred to together with an internal dictionary is stored in the memory 125. In addition, the user of the image inspection apparatus 1 stores the additional dictionary in the memory 125 in order to correctly recognize a character image for which a correct recognition result cannot be obtained by executing the OCR tool referring only to the built-in dictionary, and to obtain, as the recognition result, a character type in which the built-in dictionary does not have as the recognition result.

In a case where it is determined that the signal indicating the addition instruction is not received (step S2: NO), the control unit 12 determines whether or not the additional dictionary is stored in the memory 125 (step S3). In a case where it is determined that the additional dictionary is not stored in the memory 125 (step S3: NO), the control unit 12 ends the setting flow. On the other hand, in a case where it is determined that the additional dictionary is stored in the memory 125, the control unit 12 advances the processing to step S5.

In the present embodiment, the data for recognizing the character image as the predetermined character type, which is included in the built-in dictionary stored in the memory 125, is not a mode suitable for calculating the quality score. Thus, in a case where the additional dictionary is not stored in the memory 125, an inspection setting step related to the quality score is not performed. However, as long as the built-in dictionary has a character image for the quality score separately from the data for recognizing the character type, the inspection setting step related to the quality score may be performed even in a case where the additional dictionary is not stored in the memory 125.

In a case where it is determined that the signal indicating the addition instruction is received (step S2: YES), the control unit 12 accepts the setting information related to the additional dictionary based on the information input via the PC 2 (step S4). In step S4, the control unit 12 causes the display 15a of the PC 2 to display the workpiece image for additional dictionary setting. The user operates the PC 2 to designate a character image to be registered in the additional dictionary from the workpiece image and designate a character type corresponding to the designated workpiece image. The control unit 12 stores, as the additional dictionary, the character type designated by the user and the character image in association with each other in the memory 125. As a result, when the inspection execution unit 34 executes the OCR tool that refers to the additional dictionary, the character image designated by the user is recognized as the character type designated by the user.

After step S4, the control unit 12 determines whether or not a signal indicating that a master image for the quality score is to be registered is received from the PC 2 (step S5). For example, the signal is transmitted from the PC 2 to the control unit 12 in response to the user selecting the GUI element displayed on the display 15a of the PC 2.

In a case where it is determined that the signal indicating that the master image is registered is not received (step S5: NO), the control unit 12 determines whether or not the master image for the quality score is stored in the memory 125 (step S6). In a case where it is determined that the master image is not stored in the memory 125 (step S6: NO), the control unit 12 ends the setting flow. On the other hand, in a case where it is determined that the master image is stored in the memory 125 (step S6: YES), the control unit 12 advances the processing to step S8.

In a case where it is determined that the signal indicating that the master image is registered is received (step S5: YES), the control unit 12 accepts setting information related to the master image (step S7). In step S7, the control unit 12 causes the display 15a of the PC 2 to display, as the additional dictionary, the character image stored in the memory 125. The user operates the PC 2 to designate the master image for the quality score from the character image displayed on the display 15a. The control unit 12 stores the master image designated by the user via the PC 2 in the memory 125 in association with the character type. As a result, when the inspection execution unit 34 executes the OCR tool that refers to the additional dictionary, the quality score is calculated for the character image recognized as the character type in which the master image is registered.

After step S7, the control unit 12 determines whether or not a signal indicating that a threshold for the quality score is set is received from the PC 2 (step S8). For example, the signal is transmitted from the PC 2 to the control unit 12 in response to the user selecting the GUI element displayed on the display 15a of the PC 2.

In a case where it is determined that the signal indicating that the threshold of the quality score is to be set is not received (step S8: NO), the control unit 12 advances the processing to step S10.

In a case where it is determined that the signal indicating that the threshold of the quality score is set is received (step S8: YES), the control unit 12 accepts the setting of the threshold of the quality score via the PC 2 (step S9). In step S9, the control unit 12 stores the threshold of the quality score in the memory 125. The threshold of the quality score may be set in common to a plurality of character types regardless of the character type, or may be set individually for every character type.

After step S9, the control unit 12 accepts setting of calculation processing of the quality score (step S10). In step S10, the control unit 12 accepts setting as to whether or not to calculate a plurality of quality scores for every master image. In a case where the setting information indicating the calculation of the plurality of quality scores is received from the PC 2, the control unit 12 turns on a multiple calculation flag stored in the memory 125. The multiple calculation flag is referred to when the quality score is calculated. The setting information is transmitted from the PC 2 to the control unit 12, for example, in response to the user selecting the GUI element displayed on the display 15a of the PC 2.

After step S10, the control unit 12 ends the setting flow.

Note that, the control unit 12 repeatedly executes the setting flow while a dialog for OCR tool setting of the image inspection apparatus 1 is activated.

Processing of accepting the setting as to whether or not to calculate the plurality of quality scores for every master image corresponds to processing of “accepting setting as to whether or not to execute calculation of a first quality score and calculation of a second quality score as the calculation processing of the quality score”.

Next, an example of processing in step S4 in FIG. 3 will be described with reference to FIGS. 4 to 6.

In step S4, for example, as illustrated in FIG. 4, an image including a character type that is a target of the addition instruction is displayed on the display 15a of the PC 2. The image is a workpiece image WI including a character image region CI of six characters of “ABCDEF”, and may be acquired in advance from the imaging unit 11 and stored in the memory 125. The character image region CI includes unit character image regions UI of the six characters “ABCDEF”. Character type recognition results R as inspection results for the workpiece image WI are displayed above the unit character image regions UI.

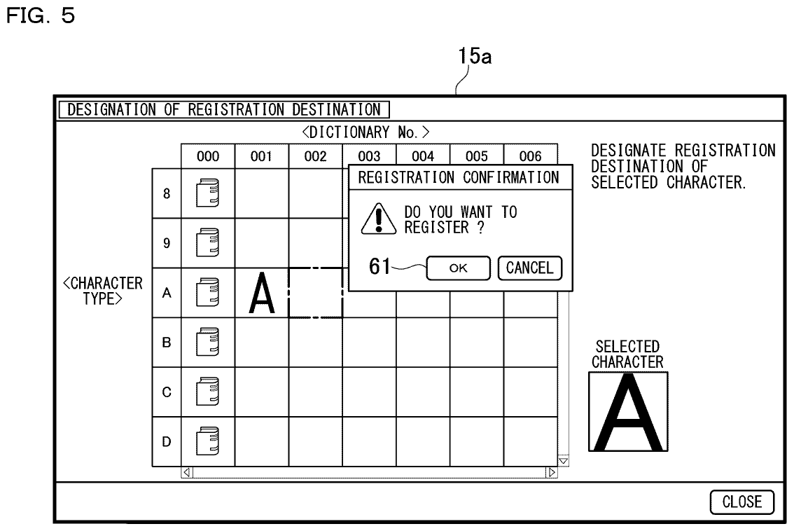

While viewing the image displayed on the display 15a, the user of the image inspection apparatus 1 specifies a unit character image region that is a target of the addition instruction, and inputs an addition instruction for adding the unit character image region as the character type recognizable by the OCR tool to the control unit 12 via the PC 2. FIG. 4 illustrates an example in which the user of the image inspection apparatus 1 operates the mouse or the keyboard constituting the PC2 and selects a unit character image region recognized as “A” among the six characters of “ABCDEF”, as the character type to be the target of the addition instruction. When the user clicks a “register” button (GUI element 51) in a state in which “A” is selected in FIG. 4, a screen displayed on the display 15a transitions to FIG. 5. In the present embodiment, for the sake of convenience in description, the unit character image region in which the character type is correctly recognized is selected, but a unit character image region selected as a target of additional learning by the user of the image inspection apparatus 1 may be a region which is recognized as the unit character image region and in which the character type is erroneously recognized or a region not recognized as the unit character image region. Accordingly, when a desired recognition result cannot be obtained by executing the OCR tool that refers to the built-in dictionary or the additional dictionary stored in the memory 125 at that point in time, the user can give an addition instruction to obtain an improved execution result of the OCR tool.

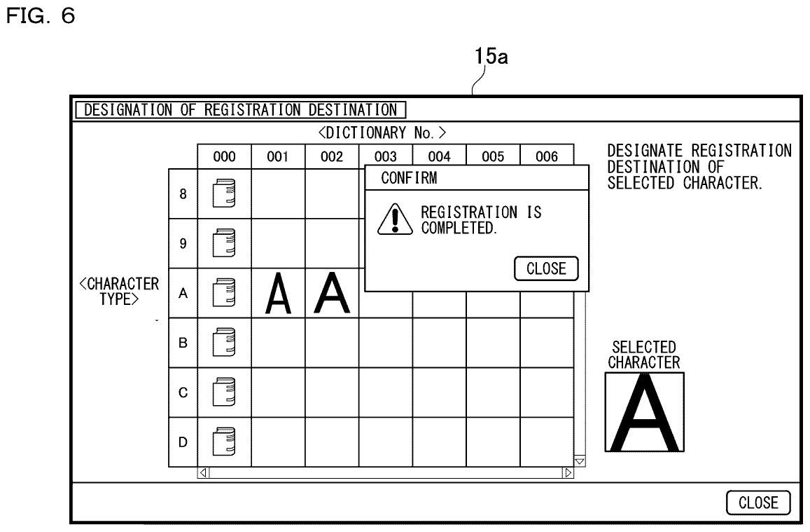

FIG. 5 illustrates an example in which the user of the image inspection apparatus 1 operates the mouse or the keyboard constituting the PC 2 to designate that a unit character image of “A” selected in FIG. 4 is registered as a dictionary No. 002 of the character type A which is a character type selected as an update target in the additional dictionary being set. As illustrated in FIG. 5, the inspection setting unit 32 displays a table including a row indicating a registration status for every character type as display information for accepting the setting related to the additional dictionary. A field of a dictionary No. 000 in the table indicates whether or not the character type is a character type registered in the built-in dictionary, that is, whether or not data necessary for recognizing the character type is stored as the built-in dictionary in the memory 125. Since character types “8”, “9”, “A”, “B”, “C”, and “D” displayed in FIG. 5 are all the character types registered in the built-in dictionary, dictionary icons are displayed in the fields of the dictionary No. 000. In the example illustrated in FIG. 5, among the character types “8”, “9”, “A”, “B”, “C”, and “D”, only the character type “A”is registered as the additional dictionary. When the user clicks an “OK” button (GUI element 61) in a state in which a registration destination is designated in FIG. 5, the unit character image of “A” selected in FIG. 4 is registered as the additional dictionary in addition to the character image registered as the dictionary No. 001, and the screen displayed on the display 15a transitions to FIG. 6.

In FIG. 5, an operation of clicking the “OK” button (GUI element 61) in a state in which the user designates the registration destination corresponds to inputting, to the control unit 12, an addition instruction for updating the selected character type “A” as the character type recognizable by the OCR tool. In accordance with the operation of the user, the control unit 12 accepts the addition instruction.

FIG. 6 illustrates that registration of the unit character image of the dictionary No. 002 of the selected character type “A” is completed, that is, the control unit 12 stores an additional dictionary in which an additional unit character image included in the addition instruction and the character type designated by the addition instruction are associated with each other in the memory 125. The “additional unit character image” refers to an image for one character added as the character type recognizable by the OCR tool. A plurality of characters such as “cm” may be treated as “one character”. In the example of FIG. 6, a character image of “A” drawn below “selected character”, that is, an additional unit character image is stored in the memory 125, as the additional dictionary of the dictionary No. 002 associated with the character type “A”. A case where the control unit 12 stores, as the additional dictionary, the additional unit character image in the memory 125 corresponds to a case where the control unit retains the additional unit character image as the additional dictionary.

Note that, in FIGS. 5 and 6, a thumbnail image is displayed as an image of the character type “A” on the display 15a. The control unit 12 may register the thumbnail image in the additional dictionary, or may register an original image of the thumbnail image in the additional dictionary. In a case where the thumbnail image is registered in the additional dictionary, a processing speed is increased.

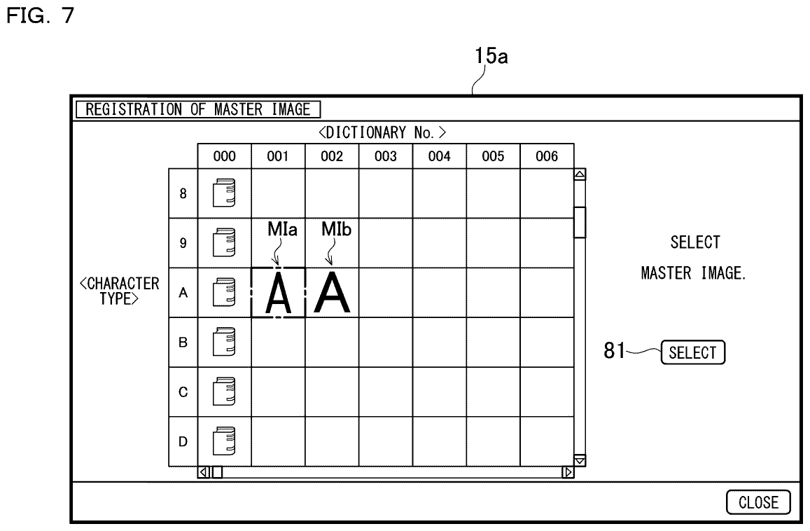

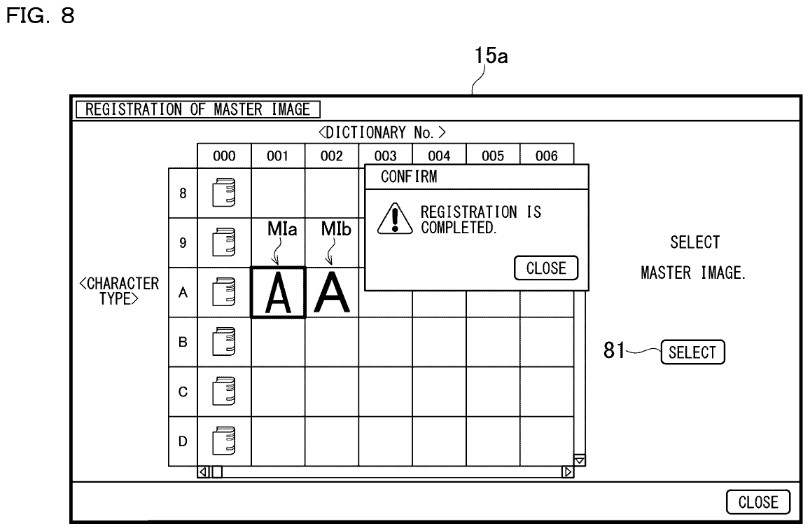

Next, an example of processing in step S7 in FIG. 3 will be described with reference to FIGS. 7 and 8.

In step S7, first, for example, as illustrated in FIG. 7, candidates MIa and MIb for the master image are displayed on the display 15a included in the PC 2 for every character type.

FIG. 7 illustrates a state in which the user of the image inspection apparatus 1 operates the mouse or the keyboard constituting the PC 2 and is selecting the candidate MIa of the candidates MIa and MIb which are images of the character type “A” of the dictionaries No. 001 and 002. In the example of FIG. 7, the candidate MIa being selected by the user is surrounded by a rectangular frame of a dashed dotted line. When the user moves a cursor, the rectangular frame indicated by the dashed dotted line moves. When the user clicks a “select” button (GUI element 81) in a state in which the candidate MIa is designated in FIG. 7, a screen displayed on the display 15a transitions to FIG. 8.

FIG. 8 illustrates that the rectangular frame surrounding the candidate MIa selected by the user is changed from the dashed dotted line to a solid line, and the candidate MIa is registered as a master image of the character type “A”. The control unit 12 accepts the registration of the master image in response to the user clicking the “select” button (GUI element 81) in FIG. 7.

In this manner, the control unit 12 sets display modes of the candidate MIa of the master image “being selected” by the user illustrated in FIG. 7 and the candidate MIa of the master image “selected” as the master image by the user illustrated in FIG. 8 to be different from each other. FIG. 7 illustrates a display mode in which the candidate MIa is surrounded by the rectangular frame of the dashed dotted line, and FIG. 8 illustrates a display mode in which the candidate MIa is surrounded by the rectangular frame of the solid line.

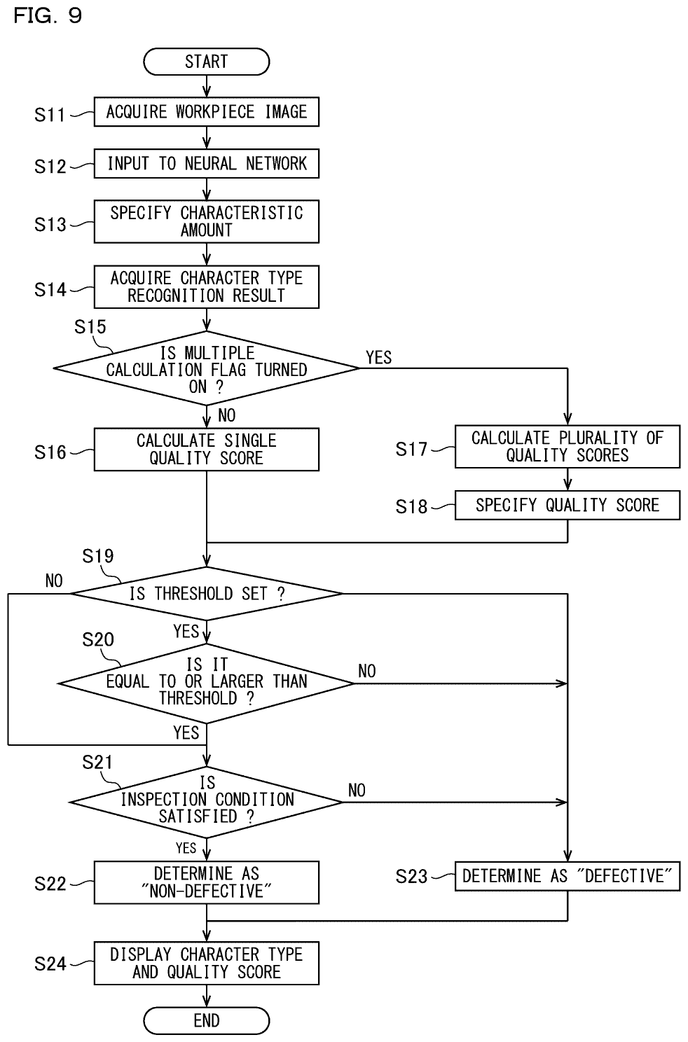

Next, an OCR tool execution flow executed by the control unit 12 will be described with reference to FIG. 9. The following kinds of processing are executed by the CPU 121 of the control unit 12.

When a trigger input instructing execution of an image inspection flow including the OCR tool is received from the PLC 4, for example, the control unit 12 starts the flow.

First, the control unit 12 acquires the workpiece image WI from the imaging unit 11 (step S11). As described above with reference to FIG. 4, the workpiece image WI may include not only one unit character image region UI but also the character image region CI including the unit character image regions UI of the six characters, for example, “ABCDEF”. Step S11 corresponds to an “image acquisition step”according to the invention.

After step S11, the control unit 12 inputs the workpiece image WI acquired in step S11 to a neural network (step S12). The processing in and after step S12 corresponds to an “inspection execution step” according to the invention. Note that, in the above description of step S12, for the sake of convenience, the control unit 12 inputs the workpiece image WI to the neural network. More specifically, the control unit 12 specifies the inspection region from the workpiece image WI by using the information indicating the inspection region set as the setting information related to the OCR tool. Then, the control unit 12 inputs, as the workpiece image WI, an image of the specified inspection region to the neural network.

The neural network is, for example, a convolutional neural network, and outputs a characteristic amount indicating a characteristic of data of the input workpiece image WI from the data. The characteristic amount is represented by a vector in a characteristic space.

After step S12, the control unit 12 specifies a characteristic amount corresponding to the unit character image region UI from the characteristic amount output from the neural network (step S13). In a case where the workpiece image WI includes the plurality of unit character image regions UI, the characteristic amount is acquired for every unit character image region UI. Note that, a position of the unit character image region UI in the workpiece image WI may be specified by a known method, and may be specified by a pixel value of the workpiece image WI, for example, as described in JP4909216B.

After step S13, the control unit 12 acquires a character type recognition result as the inspection result based on the characteristic amount acquired in step S13 and the information related to the character type recognizable by the OCR tool for every unit character image region UI (step S14). In step S14, the control unit 12 calculates a confidence level score P for every character type of the unit character image region UI by using the characteristic amount associated with every character type as the information regarding the character type recognizable by the OCR tool. The confidence level score P indicates a probability that the character type indicated in the unit character image region UI corresponds to the character type indicated in the character type recognition result R. Then, the control unit 12 outputs the character recognition result by using a character type having a high confidence level score P as the character type of the unit character image region UI. The character type recognition result indicates the character type of the unit character image region UI included in the workpiece image WI acquired in step S11 and a position (xy coordinates) of the unit character image region UI.

After step S14, the control unit 12 determines whether or not the multiple calculation flag stored in the memory 125 is turned on (step S15).

In a case where it is determined that the multiple calculation flag is not turned on, that is, the multiple calculation flag is turned off (step S15: NO), the control unit 12 calculates a single quality score for every unit character image region UI (step S16).

The quality score indicates a degree of similarity between the master image corresponding to the character type indicated in the character type recognition result acquired in step S14 and the image of the unit character image region UI included in the workpiece image WI acquired in step S11. As described above, the master image is stored in the memory 125 in association with each character type recognizable by the OCR tool. For example, the higher a degree of contamination or rubbing of the image of the unit character image region UI, and the lower a density, the lower a quality score.

A normalized correlation method is used to calculate the quality score. The normalized correlation method is a method for deriving, as the degree of similarity, a correlation coefficient between the inspection image and the master image, and a degree of similarity when the correlation coefficient is maximized is adopted as the quality score. Note that, in the present embodiment, the normalized correlation method is used, but any method may be used as long as the degree of similarity between the images can be calculated, and the quality score may be calculated by a pixel difference method. The pixel difference method is a method for deriving a difference in pixel value for every pixel between the inspection image and the master image and deriving a degree of similarity based on the differences derived for all the pixels. The inspection image may be either an image including a character and a background or an image of only a character portion excluding the background, but the latter is more preferable from the viewpoint of improving the accuracy of the quality score related to the character type.

In addition, for the calculation of the quality score, information on the position of the unit character image region UI indicated in the character type recognition result acquired in step S14 is used. That is, the control unit 12 calculates the quality score based on the position of the unit character image region UI indicated in the character type recognition result acquired in step S14. Specifically, the control unit 12 does not set the entire workpiece image WI as a calculation region of the quality score, but sets, as the calculation region, a certain range with the unit character image region UI in the workpiece image WI as a reference, collates the image of the inspection region with the master image while minutely changing xy coordinates, and calculates a highest quality score in the certain range as the quality score related to the unit character image region UI. That is, the control unit 12 performs normalized correlation search on the unit character image region UI in the workpiece image WI to calculate a single quality score. Note that, as a result of the normalized correlation search, in a case where a position where the highest quality score is calculated is different from the position of the unit character image region UI, the position where the highest quality score is calculated may be updated as the position of the unit character image region UI.

In a case where it is determined that the multiple calculation flag is turned on (step S15: YES), the control unit 12 calculates the plurality of quality scores for every unit character image region UI (step S17). The plurality of quality scores includes a first quality score and a second quality score. The second quality score indicates the degree of similarity in a case where at least one of an angle of the master image with respect to the unit character image region UI and a scale of the master image with respect to the unit character image region UI is changed, for the calculation of the first quality score. In step S17, the normalized correlation search is performed by using the master image in which at least one of the angle with respect to the unit character image region UI and the scale with respect to the unit character image region UI is changed, and the plurality of quality scores is calculated for every change content of the master image.

Note that, the plurality of quality scores may include three or more quality scores. That is, the plurality of quality scores may include a third quality score or the like in addition to the first quality score and the second quality score. In this case, the third quality score indicates the degree of similarity in a case where at least one of the angle of the master image with respect to the unit character image region UI and the scale of the master image with respect to the unit character image region UI is changed, for the calculation of the first quality score and the calculation of the second quality score. In addition, in this case, the highest quality score specified in step S18 to be described later is one of the first quality score and the second quality score, and any other quality score is the other of the first quality score and the second quality score.

In addition, in the calculation of the quality score, there may be differences in angle, scale, and the like between the inspection region and the region of the master image. In such a case, when the angle, scale, and the like of the master image with respect to the inspection region are maintained constant and the single quality score is calculated as in step S16, it is not possible to cope with the above differences. Therefore, it is possible to cope with the above differences by calculating the plurality of quality scores by changing the angle, scale, and the like of the master image with respect to the inspection region as in step S17.

After step S17, the control unit 12 specifies the highest quality score among the plurality of quality scores calculated in step S17 for every unit character image region UI (step S18). That is, the higher one of the first quality score and the second quality score is specified.

After step S16 or step S18, the control unit 12 determines whether or not the threshold of the quality score is set while referring to the information stored in the memory 125 (step S19).

In a case where it is determined that the threshold of the quality score is set (step S19: YES), the control unit 12 determines whether or not the quality score calculated in step S16 or specified in step S18 is equal to or larger than the threshold stored in the memory 125 for all the unit character image regions UI of which the positions are specified by the character type recognition result (step S20).

In step S20, the control unit 12 compares the quality score with the threshold for every unit character image region UI. Here, the threshold to be compared with the quality score may be set for every character type.

In a case where it is determined that the threshold of the quality score is not set (step S19: NO) or in a case where it is determined that the quality scores of all the unit character image regions UI are equal to or greater than the threshold (step S20: YES), the control unit 12 determines whether or not the character type indicated in the character type recognition result acquired in step S14 satisfies the inspection condition (step S21), and determines the execution result of the OCR tool in accordance with the determination result. In a case where the control unit 12 determines that the character type indicated by the character type recognition result satisfies the inspection condition (step S21: YES), the control unit 12 determines that the execution result of the OCR tool is “non-defective” (step S22). In a case where the control unit 12 determines that the character type indicated by the character type recognition result does not satisfy the inspection condition (step S21: NO), the control unit 12 determines that the execution result of the OCR tool is “defective”(step S23).

In a case where it is determined that the character type recognition result acquired in step S14 includes the unit character image region UI having the quality score that is not equal to or larger than the threshold (step S20: NO), the control unit 12 determines that the execution result of the OCR tool is “defective”(step S23).

After step S22 or step S23, the control unit 12 displays the quality score in association with the character type indicated in the character type recognition result acquired in step S14 (step S24), and ends the OCR tool execution flow.

Note that, in step S11, the image of the unit character image region UI of the workpiece image WI may be input to the neural network instead of the workpiece image WI including the character image region CI.

The highest quality score among the plurality of quality scores is specified in step S18, and the specified quality score is output in step S24, but the invention is not limited thereto. That is, any one of the plurality of quality scores may be output as the quality score, and for example, a lowest score among the plurality of quality scores may be output as the quality score. Specifically, the lower one of the first quality score and the second quality score may be output as the quality score. Alternatively, an average value of the plurality of quality scores may be output as the quality score.

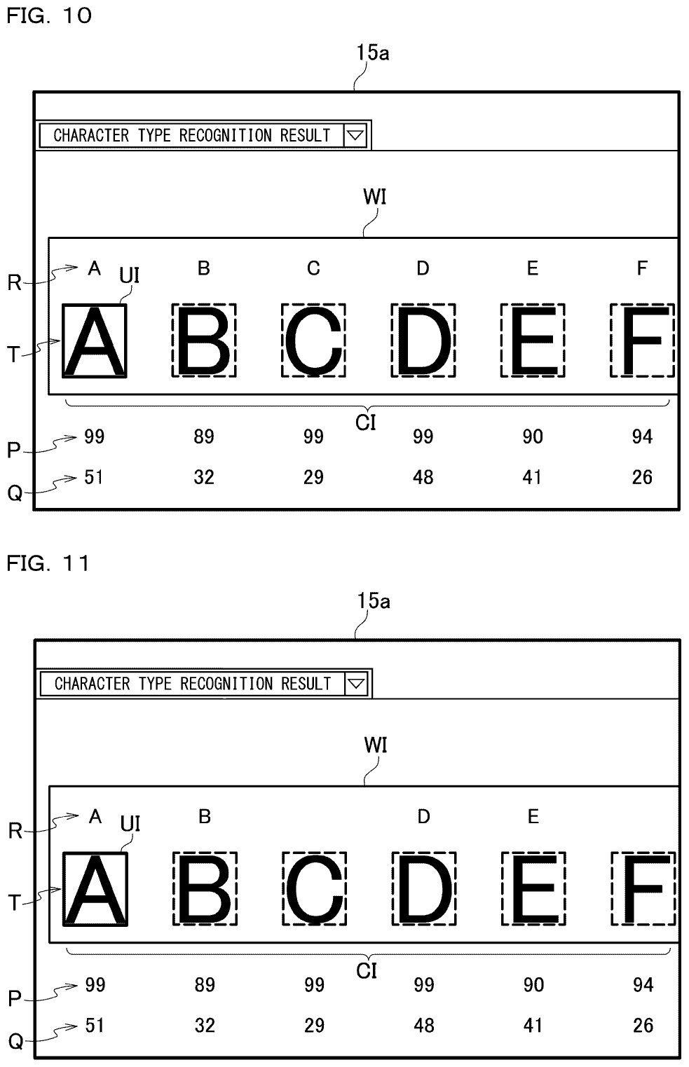

Next, an example of processing in step S24 in FIG. 9 will be described with reference to FIG. 10.

In step S24, for example, as illustrated in FIG. 10, together with the workpiece image WI, the character type indicated in the character type recognition result R acquired in step S14, the confidence level score P, and a quality score Q calculated in step S16 or specified in step S18 are displayed on one screen for every unit character image region UI on the display 15a included in the PC 2. The confidence level score P indicates a probability that the character type indicated in the unit character image region UI corresponds to the character type indicated in the character type recognition result R, and may be calculated by any method.

In FIG. 10, a frame T indicating the position of the unit character image region UI corresponding to each character type is further displayed on the screen. The frame T corresponds to a “position indication part”according to the invention.

The control unit 12 changes at least one display mode of the character type indicated in the character type recognition result R, the quality score Q, and the frame T in accordance with the quality score. For example, as illustrated in FIG. 10, the frame T corresponding to the character type “A” in which the quality score Q is equal to or larger than 50 is displayed by a solid line, and the frame T corresponding to the character types “B”, “C”, “E”, and “F” in which the quality score Q is smaller than 50 is displayed by a broken line.

The display in step S24 may be in a display mode illustrated in FIG. 11.

The screen displayed on the display 15a in FIG. 11 is substantially the same as the screen displayed on the display 15a in FIG. 10, but the character type is not output in the character type recognition result R for the character types “C” and “F” of which the quality score Q is smaller than 30 set as the threshold.

Note that, in FIG. 11, the confidence level score P and the quality score Q excluding the character type recognition result R are output for the character types “C” and “F” in which the quality score Q is smaller than 30, but the confidence level score P and the quality score Q may not be output.

As described above, according to the present embodiment, in a case where the OCR tool as the inspection tool is executed by using the neural network (see steps S12 to S14 in FIG. 9), the quality score Q is output in association with not only the character type indicated in the character type recognition result R but also the character type (see steps S16, S17, and S24 and FIG. 10 in FIG. 9). An appropriate inspection result can be obtained by using the quality score Q.

The control unit 12 calculates the quality score based on the position of the unit character image region UI indicated in the character type recognition result acquired in step S14. In a case where the control unit 12 calculates the quality score using the entire workpiece image WI as the inspection region, it takes time to calculate the quality score. In contrast, in the present embodiment, the control unit 12 does not set the entire workpiece image WI as the score calculation region, but calculates the quality score by using, as the calculation region, a certain range with the unit character image region UI in the workpiece image WI with a reference. As a result, the time required for calculating the quality score can be shortened.

The control unit 12 accepts the addition instruction for updating the character type recognizable by the OCR tool as the setting related to the OCR tool, and retains the additional dictionary in which the additional unit character image included in the addition instruction and the character type designated by the addition instruction are associated with each other (see step S2 in FIG. 3 and FIGS. 4 to 6). Thereafter, the control unit 12 accepts the registration of the master image in accordance with the input of the user based on the additional dictionary (see step S4 in FIG. 3 and FIGS. 7 and 8). In this case, the user can select the master image based on the additional dictionary and can register the master image.

The control unit 12 calculates the plurality of quality scores in step S17, specifies the highest score among the plurality of quality scores in step S18, and outputs the quality score specified in step S18 in step S24 (see FIG. 9). In this case, the plurality of quality scores is calculated by changing the angle, scale, and the like of the master image with respect to the inspection region, and thus, it is possible to cope with the differences in the angle, scale, and the like of the character type between the inspection region and the region of the master image.

The control unit 12 outputs the character type recognition result in accordance with the comparison between the quality score and the threshold (see steps S20 to S22 in FIG. 9 and FIGS. 10 and 11). In this case, an appropriate inspection result corresponding to the quality score can be obtained based on the preset threshold.

The control unit 12 displays, as an output of the quality score, the character type indicated in the character type recognition result R and the quality score Q corresponding to the character type, together with the workpiece image WI (see FIG. 10). In this case, the visibility of the inspection result by the user is enhanced.

The control unit 12 displays, as the output of the quality score, the character type indicated in the character type recognition result R, the quality score Q corresponding to the character type, and the frame T indicating the position of the unit character image region UI corresponding to the character type, together with the workpiece image WI (see FIG. 10). In this case, the control unit 12 changes at least one display mode of the character type, the quality score Q, and the frame T in accordance with the quality score. The display mode is changed, and thus, the user can easily visually recognize the inspection result corresponding to the quality score.

The control unit 12 displays, as the output of the quality score, the quality score Q together with the confidence level score P (see FIG. 10). As a result, the user can visually recognize the inspection result corresponding to the quality score Q together with the confidence level score P related to the recognition result by the OCR tool.

The control unit 12 displays the candidates MIa and MIb for the master image for every character type, and sets the display modes of the candidate MIa (see FIG. 7) of the master image being selected by the user and the candidate MIa (see FIG. 8) for the master image selected as the master image by the user to be different from each other. In this case, the user can easily select the master image.

The control unit 12 accepts setting as to whether or not to execute the calculation of the plurality of quality scores including the first quality score and the second quality score as the calculation processing of the quality score (see steps S7 and S8 in FIG. 3). The calculation of the plurality of quality scores can correspond to the differences in angle, scale, and the like of the character type between the inspection region and the region of the master image, but requires more time for processing than in a case where the single quality score is calculated. There may be users who wish to shorten a processing time than to cope with the above differences. In the present embodiment, the setting as to whether or not to calculate the plurality of quality scores is accepted in advance, and thus, it is possible to flexibly respond to the user's request.

### Second Embodiment

Next, an image inspection apparatus according to a second embodiment of the invention will be described.

After retaining the additional unit character image included in the addition instruction as the additional dictionary, the control unit of the image inspection apparatus according to the first embodiment accepts the registration of the master image in accordance with the input of the user based on the additional dictionary (see steps S1 to S4 in FIG. 3 and FIGS. 7 and 8).

In contrast, after retaining the additional unit character image included in the addition instruction as the additional dictionary, the control unit of the image inspection apparatus according to the second embodiment registers the additional unit character image as the master image regardless of the input of the user. In this case, it is not necessary for the user to perform a work of selecting the master image based on the additional dictionary, and time and effort for the user can be omitted.

### Third Embodiment

Next, an image inspection apparatus according to a third embodiment of the invention will be described.

After retaining the additional unit character image included in the addition instruction as the additional dictionary, the control unit of the image inspection apparatus according to the first embodiment accepts the registration of the master image in accordance with the input of the user based on the additional dictionary (see steps S1 to S4 in FIG. 3 and FIGS. 7 and 8).

In contrast, after retaining the additional unit character image included in the addition instruction as the additional dictionary, the control unit of the image inspection apparatus according to the third embodiment accepts the registration of the master image independently of the setting related to the additional dictionary. For example, when the master image is registered, the control unit displays not an image based on the additional dictionary but an image based on independent data different from the additional dictionary. The user can select and register the master image from the images. In this case, it is possible to flexibly accept the registration of the master image based on various kinds of data different from the additional dictionary.

### Modification

Although the preferred embodiments of the invention have been described above, the invention is not limited to the above-described embodiments, and various design changes can be made as long as they are described in the claims.

The plurality of master images may be registered for one character type. In a case where the plurality of master images is registered, for example, when the quality score is calculated in steps S16 and S17, the control unit according to the above-described embodiment may calculate a score indicating a degree of similarity with the image of the unit character image region UI for each of the plurality of master images, and may adopt a maximum value of the plurality of calculated scores as the quality score. In this case, a search range for every master image may be changed to correspond to the confidence level score P of the unit character image region UI specified in step S14. More specifically, when a plurality of master images including a first master image and a second master image are registered for one character type, the confidence level score P of the unit character image region UI is higher one of a confidence level score P1 when compared with the first master image and a confidence level score P2 when compared with the second master image. Thus, it is estimated that the quality score calculated by using the master image having the higher confidence level score P is higher than the quality score calculated by using the master image having the lower confidence level score P. Accordingly, for example, in a case where the confidence level score P1 is higher than the confidence level score P2, the plurality of quality scores can be efficiently calculated by setting the range of the normalized correlation search using the first master image to be wider than the range of the normalized correlation search using the second master image. When the quality score is output in step S24, the control unit 12 may output the dictionary No. in which the master image corresponding to the score is registered together with the adopted quality score.

Further, in a case where the plurality of master images is registered for one character type, a positional relationship between the unit character image region UI and the master image when the score adopted as the quality score is calculated in comparison with one master image among the plurality of master images may be used to determine the search range of master images other than the one master image among the plurality of master images. With such a configuration, a search range of a subsequent master image can be narrowed down to a range in which there is a high possibility that the score becomes a maximum value, and a plurality of quality scores can be efficiently calculated.

The control unit 12 is not limited to a configuration that accepts the registration of the master image based on the operation of the user. For example, regardless of the operation of the user, the registration may be accepted by using, as the master images, all the additional unit character images retained as the additional dictionaries. According to this configuration, it is possible to reduce time and effort for the user to set the master image.

The inspection execution unit is not limited to displaying the character type and the quality score, together with the workpiece image as the output of the quality score. For example, the inspection execution unit may display the character type and the quality score on a screen different from the screen on which the workpiece image is displayed.

In the above-described embodiments, the configuration in which the display 15a outputs the display information has been described, but the invention is not limited thereto. For example, the information may be displayed by the control panel 3 or the PLC 4 (external device outside the image inspection apparatus 1) connected to the control unit 12 in the above-described embodiments. In addition, the information may be output by a method other than visual information (for example, a speaker that outputs sound). In this case, the control unit may output the character type and the quality score by voice via the speaker.

The image inspection program according to the invention can be distributed by being recorded in a removable recording medium such as a flexible disk or a fixed recording medium such as a hard disk, and can be distributed via a communication line.

What is claimed is:

1. An image inspection apparatus comprising:
an image acquisition unit that acquires a workpiece image on which a workpiece appears;
an inspection execution unit that executes an inspection tool and outputs an inspection result for the workpiece image; and
an inspection setting unit that accepts setting for the inspection tool,
wherein the inspection setting unit accepts, as setting related to an OCR tool as the inspection tool, registration of a master image in association with a character type recognizable by the OCR tool,
the inspection execution unit executes the OCR tool as the inspection tool and then
inputs one of the workpiece image including a character image region and an image of a unit character image region of the workpiece image to a neural network to acquire a character type recognition result as the inspection result indicating a character type of the unit character image region and a position of the unit character image region based on information related to the recognizable character type,
calculates a quality score indicating a degree of similarity between the master image corresponding to the character type indicated in the character type recognition result and the image of the unit character image region, based on the position of the unit character image region, and
outputs the quality score in association with the character type indicated in the character type recognition result.

2. The image inspection apparatus according to claim 1,
wherein the inspection setting unit
accepts, as the setting related to the OCR tool, an addition instruction for updating the character type recognizable by the OCR tool,
retains an additional dictionary in which an additional unit character image included in the addition instruction and a character type designated by the addition instruction are associated with each other, and
accepts the registration of the master image based on the additional dictionary.

3. The image inspection apparatus according to claim 1,
wherein the inspection setting unit
accepts, as the setting related to the OCR tool, an addition instruction for updating the character type recognizable by the OCR tool,
retains an additional dictionary in which an additional unit character image included in the addition instruction and a character type designated by the addition instruction are associated with each other, and
registers the additional unit character image as the master image.

4. The image inspection apparatus according to claim 1,
wherein the inspection setting unit
accepts, as the setting related to the OCR tool, an addition instruction for updating the character type recognizable by the OCR tool,
retains an additional dictionary in which an additional unit character image included in the addition instruction and a character type designated by the addition instruction are associated with each other, and
accepts the registration of the master image independently of setting related to the additional dictionary.

5. The image inspection apparatus according to claim 1,
wherein the inspection execution unit
calculates a first quality score indicating the degree of similarity between the master image and the image of the unit character image region,
calculates a second quality score indicating the degree of similarity in a case where at least one of an angle of the master image with respect to the unit character image region and a scale of the master image with respect to the unit character image region is changed, for the calculation of the first quality score, and
outputs, as the quality score, one of the first quality score and the second quality score.

6. The image inspection apparatus according to claim 1,
wherein the inspection setting unit accepts setting of a threshold related to the quality score calculated by the inspection execution unit, and
the inspection execution unit outputs an execution result of the OCR tool in accordance with comparison between the quality score and the set threshold.

7. The image inspection apparatus according to claim 1, wherein the inspection execution unit displays, as an output of the quality score, the character type indicated in the character type recognition result and the quality score corresponding to the character type, together with the workpiece image.

8. The image inspection apparatus according to claim 1,
wherein the inspection execution unit
displays, as an output of the quality score, the character type indicated in the character type recognition result, the quality score corresponding to the character type, and a position indication part indicating a position of the unit character image region corresponding to the character type together with the workpiece image, and
changes at least one display mode of the character type, the quality score, and the position indication part in accordance with the quality score.

9. The image inspection apparatus according to claim 1,
wherein the inspection execution unit displays, as an output of the quality score, the quality score together with a confidence level score indicating a probability that a character type indicated in the unit character image region corresponds to the character type indicated in the character type recognition result.

10. The image inspection apparatus according to claim 1,
wherein the inspection setting unit
displays a candidate for the master image for every character type, and
sets a display mode of a candidate for the master image being selected by a user to be different from a display mode of a candidate for the master image selected as the master image by the user.

11. The image inspection apparatus according to claim 5,
wherein the inspection setting unit accepts setting as to whether or not to execute the calculation of the first quality score and the calculation of the second quality score, as processing of calculating the quality score by the inspection execution unit.

12. An image inspection method comprising:
an image acquisition step of acquiring a workpiece image on which a workpiece appears;
an inspection execution step of executing an inspection tool and outputting an inspection result for the workpiece image; and
an inspection setting step of accepting setting for the inspection tool,
wherein, in the inspection setting step, registration of a master image is accepted, as setting related to the OCR tool, in association with a character type recognizable by an OCR tool as the inspection tool,
in the inspection execution step,
the OCR tool as the inspection tool is executed,
one of the workpiece image including a character image region and an image of a unit character image region of the workpiece image is input to a neural network to acquire a character type recognition result as the inspection result indicating a character type of the unit character image region and a position of the unit character image region based on information related to the recognizable character type,
a quality score indicating a degree of similarity between the master image corresponding to the character type indicated in the character type recognition result and the image of the unit character image region is calculated based on the position of the unit character image region, and
the quality score is output in association with the character type indicated in the character type recognition result.

13. A non-transitory computer-readable storage medium storing an image inspection program causing an image inspection apparatus to function as:
an image acquisition section that acquires a workpiece image on which a workpiece appears;
an inspection execution section that executes an inspection tool and outputs an inspection result for the workpiece image; and
an inspection setting section that accepts setting for the inspection tool,
wherein the inspection setting section accepts, as setting related to an OCR tool as the inspection tool, registration of a master image in association with a character type recognizable by the OCR tool,
the inspection execution section
executes the OCR tool as the inspection tool,
inputs one of the workpiece image including a character image region and an image of a unit character image region of the workpiece image to a neural network to acquire a character type recognition result as the inspection result indicating a character type of the unit character image region and a position of the unit character image region based on information related to the recognizable character type,
calculates a quality score indicating a degree of similarity between the master image corresponding to the character type indicated in the character type recognition result and the image of the unit character image region based on the position of the unit character image region, and
outputs the quality score in association with the character type indicated in the character type recognition result.
